(19) United States
(12) Patent Application Publication
(10) Pub. No.: US 2017/0242833 A1
(43) Pub. Date: Aug. 24, 2017

(54) Systems and Methods to Generate Comic Books or Graphic Novels from Videos

(71) Applicant: ComicFlix, Inc., San Ramon, CA (US)

(72) Inventors: Olyvia Rakshit, San Ramon, CA (US); Santosh Sharan, San Ramon, CA (US)

(21) Appl. No.: 15/436,675

(22) Filed: Feb. 17, 2017

Related U.S. Application Data
(60) Provisional application No. 62/297,848, filed on Feb. 20, 2016.
(60) Provisional application No. 62/297,954, filed on Feb. 22, 2016.

(51) Int. Cl. G06F 17/24; G06K 9/00; G06T 15/02; G10L 15/26

(52) U.S. Cl. CPC G06F 17/241; G10L 15/265; G06K 9/00751; G06T 15/02

(57) ABSTRACT

Systems and methods which auto-create a comic book from a movie, TV show or user generated videos. The comic book can be read in an eBook or print format. This gives the user an alternate way of consuming video content by “reading” it, instead of watching and listening to it.

### RELATED APPLICATIONS

The present application claims priority to Prov. U.S. Pat. App. Ser. No. 62/297,848, filed Feb. 20, 2016 and entitled “Systems and methods to auto-generate comic books or graphic novels from videos (including movies, television shows and user generated videos)” and Prov. U.S. Pat App. Ser. No. 62/297,954, filed Feb. 22, 2016 and entitled “Systems and Methods to summarize the video and analyze the footprint of the associated frames for best reading experience as comic book format”, the entire disclosures of which applications are hereby incorporated herein by reference.

### FIELD OF THE TECHNOLOGY

At least some embodiments disclosed herein relate to the conversion of electronic content in general and more particular the conversion to video streams to electronic books.

### BACKGROUND

An average American watches about 5.5 hours of video content every day. Social media trends are around videos, images and text.

Comics, or Graphic Novels or Picture Books, are a visual medium to express ideas and stories via images. While comics date as far back as the cave paintings, more structured comic strips can be traced by to 1830 in Europe. Japanese cartoons (Manga) can be traced back to 13th century. Traditionally comics have been consumed through the print medium; the consumption of comics in this format however, has been on the decline. While the most fundamental aspect of a comic is the artwork, it is also the biggest expense in creating a comic book.

Motion pictures (e.g., movies, TV shows, user videos and the like) have been thriving industry since it's origin in 1890. More recently a lot of comic strips have been made into motion pictures with great deal of success. Over the century, a lot of good stories have been told through movies in numerous languages.

Tablet computers' adoption has finally overtaken laptops. The media consumption behavior of a general user is rapidly changing in favor of a mobile device and a tablet.

U.S. Pat. App. Pub. No. 2013/0024773 discloses a system and method to summarize interactions for presenting information to a user in a concise manner.

### BRIEF DESCRIPTION OF THE DRAWINGS

The embodiments are illustrated by way of example and not limitation in the figures of the accompanying drawings in which like references indicate similar elements.

FIG. 1 shows examples of screenshots from video and corresponding comic images with less details and cognitive overload.

FIG. 2 shows examples of a comic page that is converted from frames of a movie by adding speech bubble to comicized image, narrative text and graphical representations of special effects.

FIG. 3 shows a computing process to generate a comic from a video.

FIG. 4 illustrates a computer face detection applied on an image.

FIG. 5 illustrates an image with motion blur.

FIG. 6 illustrates an image without motion blur.

FIG. 7 shows a data processing system on which the methods of the present disclosure can be implemented.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

At least some embodiments disclosed herein bring the following facets of the media landscape together: Comics, Motion pictures, and Tablet computers.

The present disclosure includes systems and methods that allow a user to consume the same video content but as a comic book in a digital eBook, or a print format, ideally for consumption on a mobile/tablet computer. Instead of watching a movie or a show, the user may read it in a comic book format that has the content converted from the video.

Reading as an alternate medium: There are times when people prefer a written medium, as opposed to an audio-visual medium for consuming content. For example, people love to read when they commute. Watching a Harry Potter movie may be cumbersome on-the-go with network dependencies and the attention required for the consumption of visual and audio streams. The inventions of the present disclosure allows the “reading” of the same story, originally presented in a movie, in a subway in the form of a comic book, which is a whole new experience that requires only visual attention but not audio attention.

Reading/comprehension in students: The use of the inventions of the present disclosure can go a long way in kindling the interest in reading in kids. A comic book of “Charlie and the Chocolate Factory” may be more interesting for the non-reader kid; and the visual medium is easier to comprehend and may be more enjoyable to such kids, than a regular and more cumbersome chapter book.

Educational videos on complex concepts can also be explained better by funny comic books, an alternate way for students to learn as opposed to watching and listening to a video.

Less cognitive overload: While the content of the video can be told via a picture book, by taking snapshots of the video and putting it in a book format, there is a cognitive overload in reading such a picture book because the brain has to process all the little details of the high resolution images taken from a video.

Comic images generated using techniques of the present disclosure lack the excessive details of a high resolution image from the video. The resulting comic books have images where those minute details in the images have been eliminated, thus reducing the cognitive overload on the reader and making it easy for the reader to focus on the story. When the techniques of comicizing images are used, the brain finds it easier to consume simpler pictures with minimal shades over complex details.

Cost: Producing comic books can be cost prohibitive expensive given the artwork involved. The techniques of the present disclosure reduce the cost of producing comic books by automating a portion or the entire process.

Comics can be created from videos using the following process specifically adapted for computer operations/automations.

Image and Dialog Extraction: A software tool splits a given video (e.g., into a plurality of scenes), and extracts dialogs/subtitles from the video and associated frames/images of the video. It also extracts additional images using an algorithm or rules engine to best tell the story. A rules engine determines the accurate timestamp where there is a dialog or a speech occurrence and grabs the precise image for that timestamp. This technique is described in more detail further below in the section entitled “SUMMARIZE AND ANALYZE VIDEO”. This software tool selects only the best and visually appealing video images and discards images that are too dark, too blurry or too repetitive.

Optionally Apply Image Filters to Generate a Comic Effect (or other effect to make it easy to consume in a readable format): A software script converts each image of the video to a comicized format. “Comicizing” an image involves using appropriate parameters of image filters to remove some details of the high definition frames/images grabbed from the video (e.g., by increasing contrast of the image), and/or using basic colors on simple outlines to render a very simple hand-drawn, comic-like look and feel for the image.

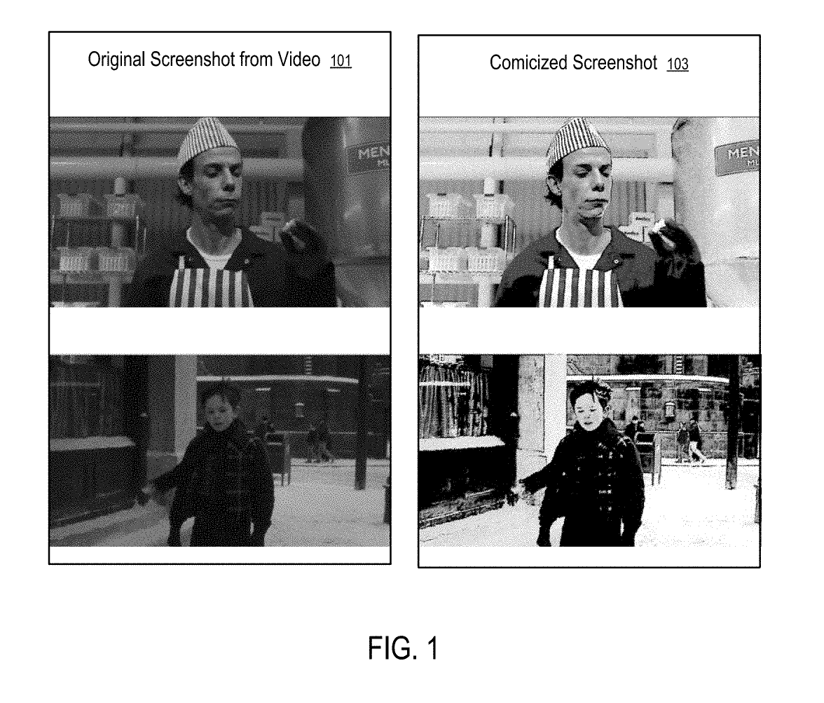

FIG. 1 shows examples of screenshots (101) from video and corresponding comic images (103) with less details and cognitive overload.

Comic Markup Language Generator and Reader: A software tool generates a XML format to represent the comic and an editor allows the visually editing of the XML or enables the comic creator to:

I) easily choose the images that go into the comic;

II) easily choose the dialog that pair with each selected image;

III) specify the layout for each image;

IV) specify a contextual narrative text on each image to help the reader string all the images and dialogs together; and

V) apply any additional filters on the images.

A sample extract of the comic markup language is provided below.

```
<CML>
  <SelectedImageDir>C:</SelectedImageDir>
  <SubtitleDir>C:</SubtitleDir>
  <Frame>
    <Image>HG_0020_5_06.png</Image>
    <Layout>1_4_1</Layout>
    <Narrative>SOME time AGO in DISTRICT 12, in the country of
    “Panem”, screams RIPPED THROUGH the air..</Narrative>
    <Lettering>
      <Sound>AAAhh Noo!></Sound>
      <Sound>Shhhhh</Sound>
    </Lettering>
  </Frame>
  <Frame>
    <Image>HG_0020_5_10.png</Image>
    <Layout>1_4_2</Layout>
    <Bubble>
      <Dialog>HG_0020_5_06.txt</Dialog>
      <Dialog>HG_0020_5_06.txt</Dialog>
    </Bubble>
    <Narrative>A LITTLE GIRL HAS HAD A BAD DREAM AND
    WAKES UP SCARED, HER OLDER SISTER COMFORTS HER...
    </Narrative>
  </Frame>
<CML>
```

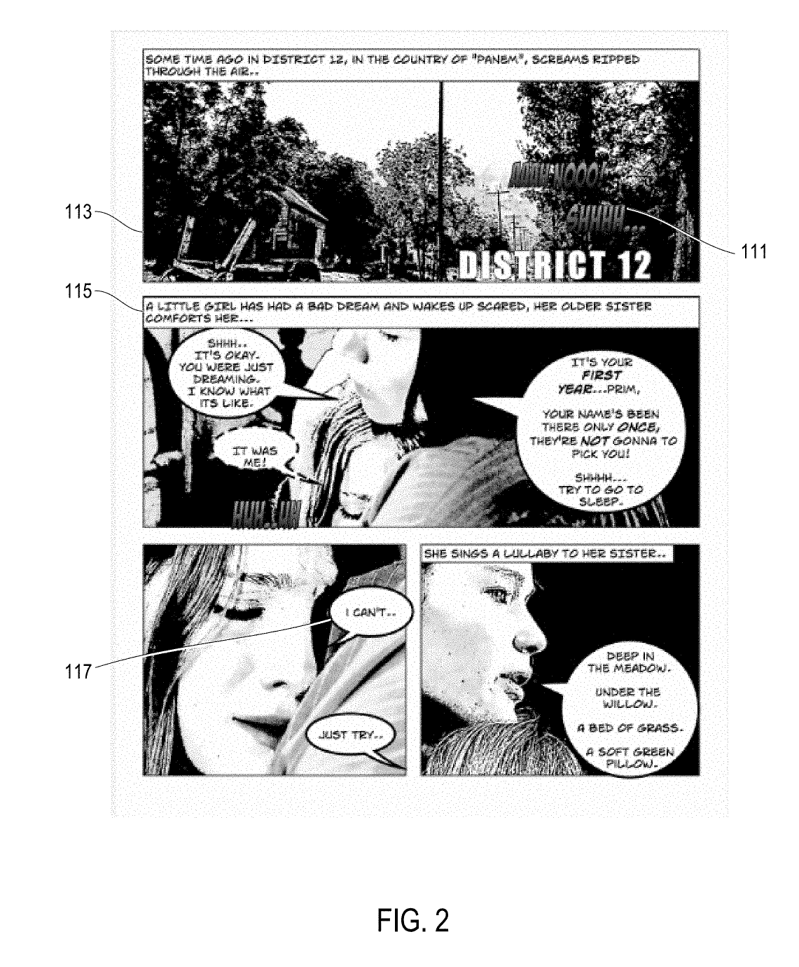

FIG. 2 shows examples of a comic page that is converted from frames of a movie by adding speech bubbles (e.g., 117) to the comicized images (e.g., 113) of the movie/video frames and other items, such as narrative text (115) and graphical representation of sound effects (e.g., 111).

Comic Generator: A software tool that reads the markup language CML and appropriately creates the final electronic book (e.g., in a pdf or html format) by placing the images, speech bubbles, narrative texts and special effect balloons in the right place.

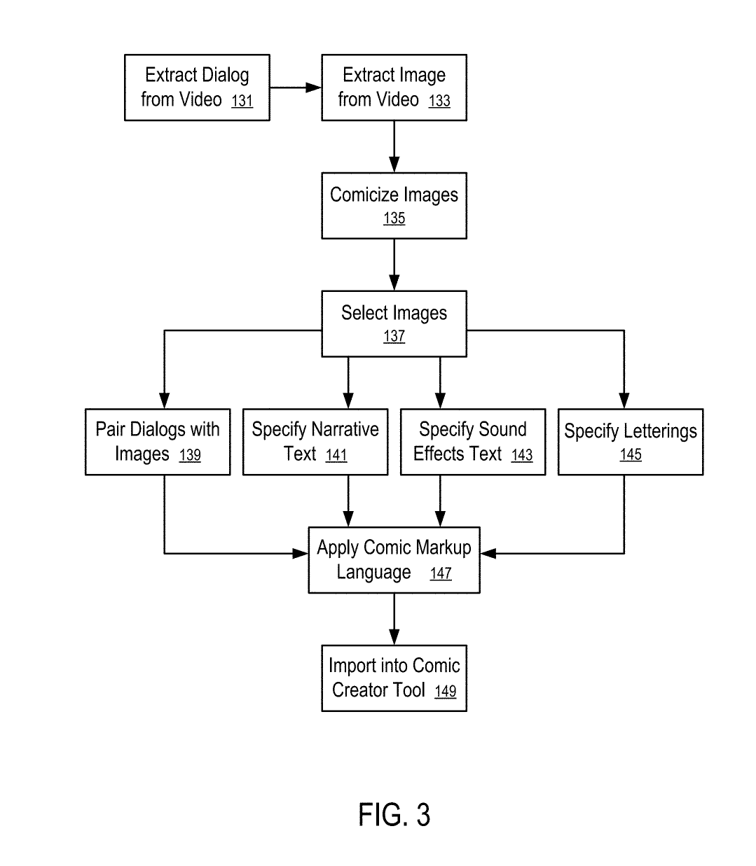

FIG. 3 shows a computing process to generate a comic from a video. In FIG. 3, a computing device is configured to: extract (131) dialogs from a video (e.g., using speech recognition techniques); extract (133) frames/images (e.g.,101) from the video; comicized (135) the extracted images (e.g., 101) to generate the comicized images (e.g., 103) by applying image filters to reduce or remove local details and highlight outlines of major features; select (137) images (e.g., selecting the best and visually appealing video images and discarding images that are too dark, too blurry or too repetitive); pair (113) the extracted dialogs with the comicized images; specify (141) narrative text (115); specify (143) sound effects text (111); specify (145) letterings (117); apply (147) a comic markup language to combine the text and images generated for the comic book; and import (149) the comic input, combined with the comic markup language, into a comic creator tool to generate an eBook. The operations of paring (139) dialogs with images (139), specifying (141) narrative text, specifying (143) sound effect text (143), and/or specifying letterings (145) can be performed in a graphical user interface provided by the Comic Markup Language editing tool.

### Summarize and Analyze Video

The techniques of the present disclosure identify the precise frames from a video, identify the speakers for each frame, and convert each frame into a hand-drawn look and feel image (available in the standard forms .png, .jpeg, .jpg., .tiff etc.). The pool of selected images can be stitched together into pages of a comic book. As a result, comic books can be generated from movies or TV dramas or any comparable videos with a story. The techniques improve the process of creating content in a whole new format from audio (or subtitle) and visual data of videos.

By converting a video clip into an eBook in a comic form, a consumer can:

Experience the video content in a different (readable) format: The consumer can listen and see a video, but when he reads the same video in a story format, he can do so at his own pace. He can read and re-read parts of a particular dialog, thus exercising his own control on the pace of his experience, which he may not have with a video medium (unless he is fond of hitting the replay button over and over again to revisit parts of the video). If the video can be read, the revisiting experience is much easier.

Increase engagement with the video content: The consumer is able to engage with the contents more intimately. Reading the contents of the video appeals to a different part of his brain which forces him to imagine and fill in gaps in his mind based on visual and textual cues he gets while reading. His brain is thinking more, hence he retains and remembers more while engaging with a reading medium as opposed to a video.

Some techniques for the conversion from a video stream to an electronic book are described below.

Creating a new readable format from videos: A software tool is used to extract the building blocks to create a human readable format from videos. The technology has numerous applications from encouraging young readers to read, to addressing issues related to high bandwidth requirements for playing HD videos. Creating new formats from videos using this technology has been found beneficial to kids with special needs, especially when they have previously seen the video. The other use case is one with streaming providers. For example, when a user interacts with a streaming provider's app and looks at the thumbnails of 100 s of videos, there can be a “Read” button in addition to a “Watch” button next to the videos, where the “Read” button allows the user to read the automatically generated comic books of the videos, which takes less bandwidth to download and can be “read” more quickly as previews of the videos.

The technology opens up a world of possibilities. Human beings love options. Videos are engaging and fun to watch, but sometimes we want to just read the stories they represent. And now with this technology we can create readable formats quickly and inexpensively from videos and in scale.

Search: Another specific problem related to videos is the ability to search within a video content. Imagine a product manager talking in a video for a software product. He says a bunch of things on the importance of his software product, the value it adds and how it can be purchased; but there's no easy way right now to go back and search for all the things I heard in the video. There are many solutions that are being worked upon related to video search, but the output of the technologies of the present disclosure, when strung together in to a story book format, can also help with the goal of an efficient search within a video.

For example, a readable format in PDF form can be provided next to every video. Every word spoken in the video is in the PDF and every frame in the video (necessary to tell the story) is also in the PDF. Search engines can now pick up the contents of the video via this PDF; thus the search results can lead us to so many relevant videos out there. No more painfully tagging each video with relevant keywords with the hope of getting picked up by Google.

Promotional Purposes: Brands and content owners are constantly looking for newer ways to engage with their followers. What better way to engage than telling a story. TV spots are expensive, running video ads are dependent on bandwidth and cost attributes. The techniques of the present disclosure allow brands to inexpensively and quickly create stories in a readable format from the section of videos that could not be on air. So the promotion can begin the story on TV and end it in print or a digital readable format that can be consumed on a mobile device. The techniques can provide the building blocks to create a readable format from the beginnings of movies and TV shows, e.g., to allow the “reading” of the first 10 minutes of a movie on a user's tablet, that's going to leave user hooked to walk into the theater and see the whole movie.

User Generated Content: People not only consume 5.5 hours of video content every day, but also create and capture videos on all happy occasions. Human beings need ways to express themselves creatively and differentiate with each other based on the unique stories of their lives. The techniques of the present disclosure provide the building blocks to create the stories from the videos taken on special occasions, such as weddings and vacations and birthday parties and prom nights.

The techniques of the present disclosure involve several steps in aggregating a set of images and text that are extracted from a video to tell the story presented in the video. The aggregate set of images is provides a “Final Selection” of images for the creation of an electronic book.

Extract an Image When a Speech Occurs: Either using speech to text routines or extracting subtitle files from DVDs, a software tool obtains the timestamps when exactly there are words spoken in the video. The output is similar to the following example, where the text representations of the audio content (or subtitle data) are identified with the timestamps of their associated frames of video images.

2
00:00:51,260 --> 00:00:52,468
(BLOWS WHISTLE)
3
00:00:52,761 --> 00:00:54,262
Everybody inside!
4
00:00:54,346 --> 00:00:56,639
Come on.
Time for your chores.
5
00:00:56,765 --> 00:00:58,933
But, Sister Mary-Mengele, the game's tied.

An image can be grabbed for each timestamp when a dialog is spoken and added to the repository of grabbed images. For periods of the video when there is no speech, additional images can be grabbed at timed intervals and added to the repository.

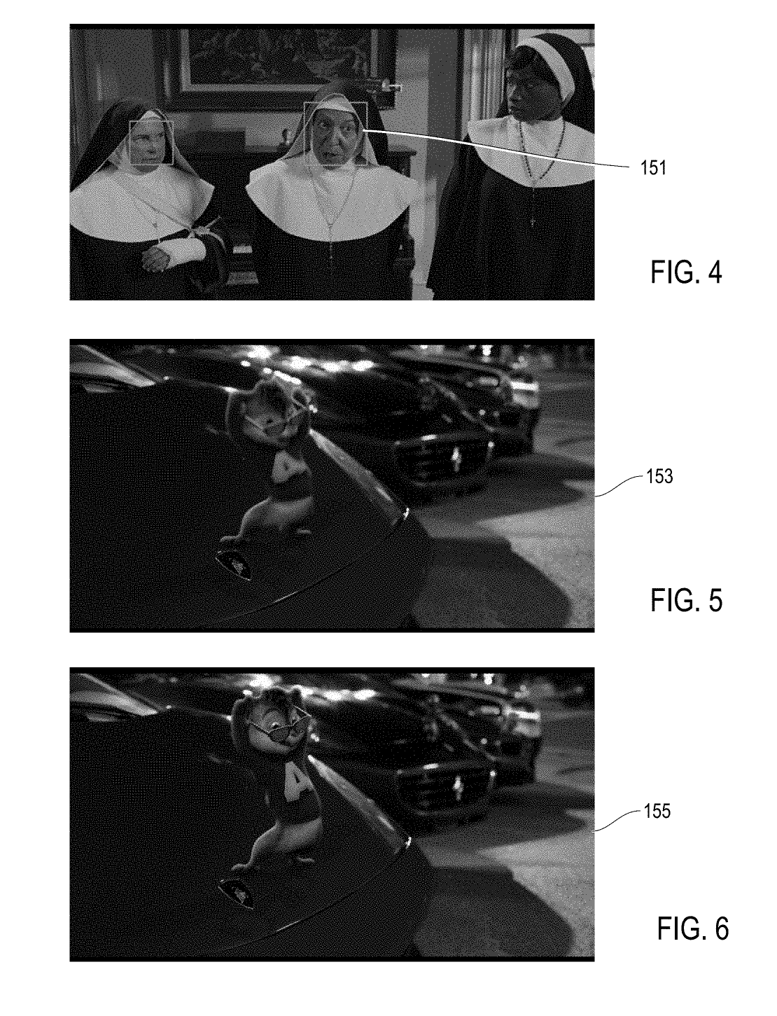

Speaker Detection: For each image in the repository of grabbed images, extracted as a result of when a speech or dialog has occurred, the speaker is to be identified via a software tool. For example, a face detection routine is run on the grabbed image (e.g., as illustrated in FIG. 4). Once a face is detected there is a rectangle drawn around the face (a bounding box of the detected face). The rectangle has a length L and a breadth B. Since we know the timestamp t associated with each image, the algorithm grabs the next image at (e.g., at time t+200 s) and gets the face detection values for the next image. Also the algorithm gets an image at (e.g., at time t−200 s) and grabs an image at that timestamp.

Thus, the software tool obtains data illustrated below, which identifies the locations of the bounding boxes of the faces of the speakers in the video images.

```
Image 1 (at t seconds)
Speaker 1 :
  L = 29mm
  B = 20 mm
X,Y : 220, 300
Image 2 (at t+200 seconds)
Speaker 1 :
  L = 31mm
  B = 20 mm
X,Y : 220, 300
Image 3 (at t-200 seconds)
Speaker 1 :
  L = 30mm
  B = 20 mm
X,Y : 220, 300
```

From this data, the software detects that the length of the bounding box of the face of Speaker 1 varies over the course of the image slices, which indicates that Speaker 1's jaws are moving which contributes to the length of the head being longer when images are analyzed across minute slices of timeframes.

In the above example, “X, Y:220, 300” denotes the X, Y coordinates of where Speaker 1's head/face in the video image. When stringing the images together into a story, the software tool uses this location to place the speech bubbles on the image for Speaker 1.

Thus, the speaker corresponding to a dialog extracted from the audio data (or subtitle data) of the video can be detected via detecting the bounding boxes of faces recognized from the corresponding video images that have changes consistent with speaking in the video.

Scene Change: At certain instances when there is a scene change, the algorithm detects when the scene changes completely and grabs an image the moment the scene change occurs. The image representing the scene change is added to the repository of grabbed images. Thus, any drastic scene change can cause the software tool to grab a new video image/frame for the comic book.

Motion Blur: For every image in the repository of grabbed images, operations are performed to ensure that the image is the sharpest one available without any motion blurs (e.g., as illustrated in FIGS. 5 and 6). Motion blur is determined based on finding the maximum pixel difference over a small range of pixel values in a small area of the image. The sharpness of the image is calculated based on the pixel difference values and a lower sharpness value indicates that the image is blurred. If a particular image at timestamp t is blurred, the next image at (t+100 s) is grabbed until the sharpness value is above the acceptable threshold. For example, when the initially grabbed image 153 illustrated in FIG. 5 is found to have motion blur, the software tool grabs the next image 155 illustrated in FIG. 6 and replace the image 153 when the next image 155 has less motion blur or no motion blur. Thus, a best non-blur image associated with a dialog can be grabbed as a candidate for a comic frame. Blur can be quantified based on maximum pixel difference over a small range of pixel values in a small area of image.

Removal of Duplicative Images: For every image in the repository of grabbed images, the software tool runs to remove the duplicate images that may have been added inadvertently and/or substantially similar to each other and thus not interesting to a comic book audience.

The above technology can be applied to live video (broadcast or a stream) or a recorded video (movie). So for instance a kid can “read” the Barney on an iPad while it is broadcasted in the TV almost simultaneously or in real time when this technology is used to generate graphic novels from a video stream in a fully automated model.

External overlays can be added to the content “just in time” to enhance the experience. For instance if this technology can be applied to sports and other historical data around the teams or individual players can be overlaid to enhance the comic reading experience.

The same technology above can also be used to generate a video summary and create a smaller sequence of images to compress 30 min of a video into 10-20 pages of graphic novel that can be consumed in 5 min.

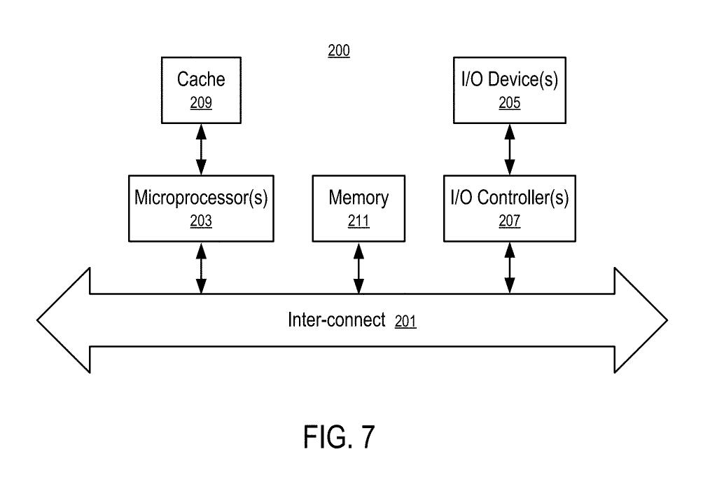

The present disclosure includes the methods discussed above, computing apparatuses configured to perform methods, and computer storage media storing instructions which when executed on the computing apparatuses causes the computing apparatuses to perform the methods. The methods/software tools can be implemented on a computing device, such as a data processing system illustrated in FIG. 7 with more or less components.

FIG. 7 shows a data processing system on which the methods of the present disclosure can be implemented. While FIG. 7 illustrates various components of a computer system, it is not intended to represent any particular architecture or manner of interconnecting the components. Other systems that have fewer or more components than those shown in FIG. 7 can also be used.

In FIG. 7, the data processing system (200) includes an inter-connect (201) (e.g., bus and system core logic), which interconnects a microprocessor(s) (203) and memory (211). The microprocessor (203) is coupled to cache memory (209) in the example of FIG. 7.

In FIG. 7, the inter-connect (201) interconnects the microprocessor(s) (203) and the memory (211) together and also interconnects them to input/output (I/O) device(s) (205) via I/O controller(s) (207). I/O devices (205) may include a display device and/or peripheral devices, such as mice, keyboards, modems, network interfaces, printers, scanners, video cameras and other devices known in the art. When the data processing system is a server system, some of the I/O devices (205), such as printers, scanners, mice, and/or keyboards, are optional.

The inter-connect (201) includes one or more buses connected to one another through various bridges, controllers and/or adapters. For example, the I/O controllers (207) include a USB (Universal Serial Bus) adapter for controlling USB peripherals, and/or an IEEE-1394 bus adapter for controlling IEEE-1394 peripherals.

The memory (211) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A non-transitory computer storage medium storing instructions which when executed on a computing device cause the computer device to perform a method, the method comprising:
extracting, from a video stream having frames of images and audio data, dialogs of actors presented in video stream using a speech recognition technique;
extracting representative frames of the video stream corresponding to the dialogs;
converting the representative frames into images of a predetermined style;
applying a comic markup language to combine the images with the dialogs into a set of input data; and
generating an electronic book from the set of input data.

2. A method, comprising:
extracting, from a video stream having frames of images and audio data, dialogs of actors presented in video stream using a speech recognition technique;
extracting representative frames of the video stream corresponding to the dialogs;
converting the representative frames into images of a predetermined style;
applying a comic markup language to combine the images with the dialogs into a set of input data; and
generating an electronic book from the set of input data.

3. A computing device, comprising:
a least one microprocessor;
a memory storing instructions which when executed by the at least one microprocessor cause the computer device to:
extract, from a video stream having frames of images and audio data, dialogs of actors presented in video stream using a speech recognition technique;
extract representative frames of the video stream corresponding to the dialogs;
convert the representative frames into images of a predetermined style;
apply a comic markup language to combine the images with the dialogs into a set of input data; and
generate an electronic book from the set of input data.
